(19) United States
(12) Patent Application Publication
(10) Pub. No.: US 2007/0079793 A1
(43) Pub. Date: Apr. 12, 2007

(54) System and method for avoiding loss of prime in a diesel engine fuel system

(76) Inventors: Anthony J. Cook, Fort Wayne, IN (US); James C. Bradley, New Haven, IN (US); Rodney J. Klinger, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/244,923

(22) Filed: Oct. 6, 2005

(51) Int. Cl. F02M 37/08

(52) U.S. Cl. 123/198 D; 123/198 F

(57) ABSTRACT

A system and method for avoiding loss of prime in a primed fuel system of a diesel engine (10) that propels a motor vehicle. With the engine running, a control system (14) shuts down the engine when a fuel level sender (20) indicates an incipient risk of the fuel system losing its prime due to insufficient fuel in the tank (16). In one embodiment, the engine cannot be re-started until more fuel is added to the tank. Another feature allows engine re-starting and limited running after a shut-down by first turning the ignition switch (48) to OFF.

### FIELD OF THE INVENTION

This invention relates to motor vehicles that are powered by diesel engines, in particular to a system and method for avoiding loss of prime in the fuel system when the fuel supply approaches empty.

### BACKGROUND OF THE INVENTION

When a motor vehicle engine runs out of fuel, the engine stops and cannot be restarted until the fuel supply is replenished. The fuel systems in larger vehicles like cars and trucks typically have electronically controlled fuel injectors that inject fuel into engine cylinders under pressure. Because a fuel tank is typically located outside an engine compartment, a pump is needed to move fuel from the tank to the fuel injection system at the engine, and once the fuel has been moved, the pressure still needs to boosted to one that is high enough for diesel injection.

If the fuel tank is pumped dry, a pump begins to cavitate and is prone to losing prime. The injection system may also be affected.

The very nature of a diesel engine, and diesel fuel as well, tend to make re-priming the engine difficult, especially in cold weather. Consequently, regular drivers of commercial trucks are usually careful enough to keep fuel in their tanks from running too low.

That may not be the case for trucks that are rented from rental fleets. Because such trucks may not be rented to regular drivers, it is believed that there is a greater risk that a rented commercial truck may run out of diesel fuel. Such an event may incur the expense of having to call a service technician to the location where the truck ran out of fuel, or even that of having the truck towed to a service facility.

Some motor vehicles are equipped with low-fuel warning systems that issue visible and/or audible warnings when the in-tank fuel supply reaches at level suggesting that the driver needs to re-fill fairly soon. For whatever reason, such a warning may on occasion be ignored, sometimes without adverse consequence, but at other times with the consequence of running out of fuel when no fuel is readily available, and the further consequence of causing the fuel system to lose its prime.

### SUMMARY OF THE INVENTION

The present invention relates to a system and method for avoiding loss of prime before the fuel supply level drops so low that the fuel system is at risk of losing prime.

According to one generic aspect, the invention relates to a motor vehicle comprising a diesel engine that propels the vehicle and comprises a fuel system that has been primed. A sender indicates the level of diesel fuel in a tank that holds a supply of diesel fuel for the engine. An engine control system that provides control of the engine including control of engine fueling is effective, with the engine running, to shut down the engine when the sender indicates an incipient risk of the fuel system losing its prime due to insufficient fuel in the tank.

According to another generic aspect, the invention relates to a method of avoiding loss of prime in a primed fuel system of a diesel engine that propels a motor vehicle having a fuel tank for holding diesel fuel for the engine and a sender for indicating the level of diesel fuel in the tank. With the engine running, a control system shuts down the engine when the sender indicates an incipient risk of the fuel system losing its prime due to insufficient fuel in the tank.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a schematic diagram illustrating a portion of a motor vehicle engine and fuel system relevant to an understanding of principles of the present invention.

FIG. 2 is a schematic diagram illustrating additional detail

### DESCRIPTION OF THE PREFERRED EMBODIMENTS

A motor vehicle, such as a truck, is powered by a diesel engine 10 disposed in an engine compartment of the vehicle. A fuel system for engine 10 comprises a fuel injection system 12 whose operation is controlled by an engine control system 14.

Control system 14 comprises one or more processors for processing data from various sources to control various fueling parameters such as injection control pressure, injection timing, and injection quantity.

The fuel system further includes one or more tanks, such as tank 16, for carrying diesel fuel for engine 10. Fuel is moved from tank 16 to the engine compartment by a pump 18 that may be disposed internal or external to tank 16.

A sender 20 is disposed in tank 16 for indicating the amount of fuel in the tank. A common type of sender comprises a body 20A that is mounted in any suitably appropriate way and a float arm 22 that carries a float 24 that seeks the level of fuel in the tank. As float 24 moves vertically with changes in fuel level, float arm 22 is correspondingly positioned on body 20A to operate a device such as a variable resistor that is connected to a circuit providing a signal for informing the driver of the vehicle of the amount of fuel in the tank.

In accordance with principles of the invention, the signal from sender 20 is also utilized by engine control system 12. When the signal indicates a fuel level corresponding to an incipient risk of the fuel system losing its prime due to insufficient fuel in tank 16, control system 12 shuts down engine 10. In that way, the fuel system retains its prime. Once it has shut down engine 12 in this way, the control system does not allow the engine to be re-started until fuel has been added to tank 16 to bring the fuel level to one that is higher than the one that caused the shutdown.

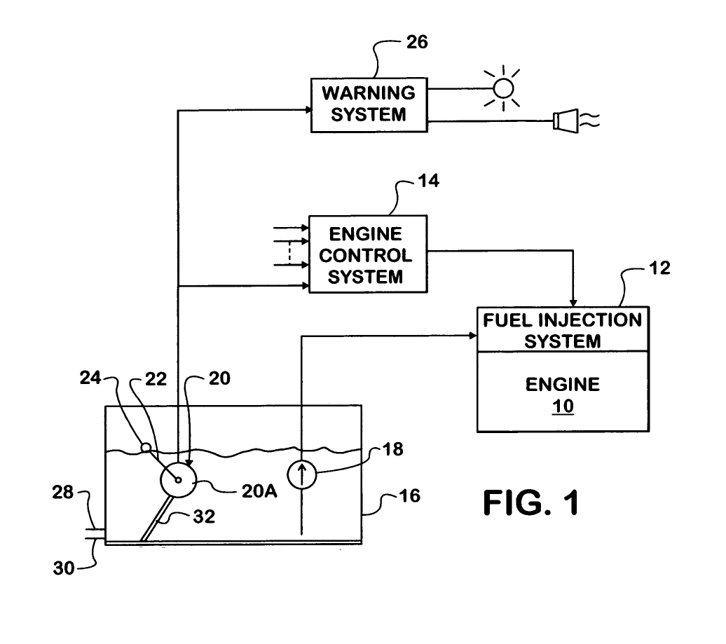

The vehicle also has a warning system 26 for issuing a low-fuel warning, either visibly and/or audibly. System 26 will first issue a low-fuel warning at an indicated fuel level in advance of the level indicating an incipient risk of the fuel system losing its prime due to insufficient fuel in the tank. That warning is typical of known warning systems in that it is intended to alert the driver of a need to re-fuel fairly soon, but it is not indicative of an imminent engine shutdown due to incipient risk of loss of fuel system prime. FIG. 1 shows a fuel level 28 representing that at which the low-fuel warning might be given.

FIG. 1 also shows a lower fuel level 30. It is when fuel level in tank 16 drops to level 30 that warning system 26 issues an imminent shutdown warning because sender 20 is indicating an incipient risk of the fuel system losing its prime due to insufficient fuel in the tank. Some margin of time for allowing the driver to move the vehicle off the road or to park the vehicle is thereafter provided before actual shutdown occurs.

For purposes of improved accuracy, sender 20 may be of the type that includes a bottom reference feature that references the signal to tank bottom as sensed by a member, such as member 32 in FIG. 1, being forced against the bottom wall of the tank. This feature accounts for slight dimensional differences in sender mounting location from tank-to-tank in mass-produced vehicles due principally to dimensional tolerances to the bottom wall, and to any deformation that may occur in the bottom wall.

Accuracy is also improved by processing the signal from the sender according to an algorithm to attenuate the effect of fuel slosh in the tank.

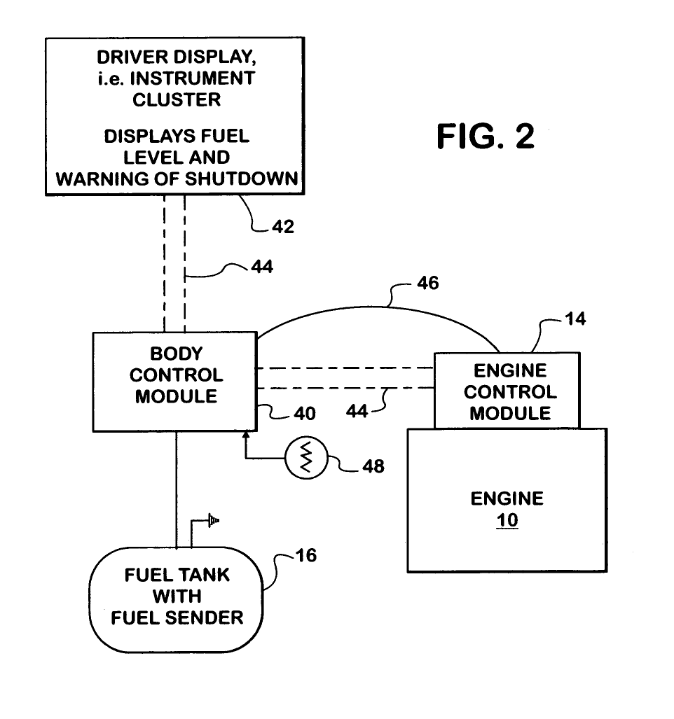

The additional detail included in FIG. 2 shows an embodiment where the motor vehicle has a body control module 40 with which a driver display 42 is associated. The fuel level sender contained in tank 16 provides a signal to body control module 40 indicating the level of fuel in the tank.

Body control module 40 is an on-board electronic system that is for the most part associated with components and devices in the cab or body of the vehicle, such as -driver display 42. Module 40 also interfaces with other modules, such as engine control module 14 that corresponds to engine control system 14 in FIG. 1. The interfacing typically occurs via a data link 44.

To avoid loss of prime, body control module 40 can signal engine control module 14 via data link 44 to shut off engine 10 when the fuel level sensed by the in-tank sender reaches a level corresponding to level 30 in FIG. 1. Advance warning of shut-down can be given by module 40 to display 42.

If an engine shut-down actually occurs, a feature shown in FIG. 2 allows the engine to be re-started and operated for a limited time. This features allows the vehicle to be moved to a more favorable location if shut-down occurs in a less favorable one. The feature involves the use of the vehicle's ignition switch 48, which is typically associated with body control module 40.

When a shut-down occurs in order to avoid loss of prime, the fuel level that triggers shut-down is chosen to allow some small amount of additional fuel consumption before prime is lost so that the vehicle can be driven to a more favorable location.

Shut-down would be expected to occur with ignition switch 48 in ON position. If the switch is thereafter turned to OFF position, the signaling of OFF position to body control module 40 resets the body and/or engine control module, as appropriate, to a condition that allows the engine to be cranked and re-started and then to run either for a limited amount of time, or until some small additional amount of fuel has been consumed.

FIG. 2 also shows a “hard-wired” connection 46 from body control module 40 to engine control module 14 that can -be used to directly interrupt fueling instead of having engine control module 14 process data from module 40 via data link 44 in order to stop the fueling.

While a presently preferred embodiment of the invention has been illustrated and described, it should be appreciated that principles of the invention apply to all embodiments falling within the scope of the following claims.

What is claimed is:

1. A motor vehicle comprising:
a diesel engine that propels the vehicle and comprises a fuel system that has been primed;
a sender for indicating the level of diesel fuel in a tank that holds a supply of diesel fuel for the engine;
an engine control system that provides control of the engine including control of engine fueling, and that is effective, with the engine running, to shut down the engine when the sender indicates an incipient risk of the fuel system losing its prime due to insufficient fuel in the tank.

2. A motor vehicle as set forth in claim 1 wherein the sender comprises a tank bottom reference element that references the level of fuel to the bottom of the tank to attenuate the effect of tank bottom wall deformation on fuel level.

3. A motor vehicle as set forth in claim 1 wherein the sender provides a signal indicating the fuel level, and a processor processes the signal according to an algorithm that attenuates the effect of fuel slosh in the tank on fuel level indicated by the sender.

4. A motor vehicle as set forth in claim 1 including a warning system for issuing a low-fuel warning at an indicated fuel level in advance of the level indicating an incipient risk of the fuel system losing its prime due to insufficient fuel in the tank.

5. A motor vehicle as set forth in claim 4 wherein the warning system is arranged to issue an imminent shutdown warning in advance of the control system shutting down the engine because of the sender indicating an incipient risk of the fuel system losing its prime due to insufficient fuel in the tank, but at a lower indicated fuel level than the level at which the low-fuel warning was issued.

6. A motor vehicle as set forth in claim 1 in which the control system is arranged to disallow re-starting of the engine until fuel has been added to the tank to bring the fuel level to one that is higher than the one that caused the shutdown.

7. A motor vehicle as set forth in claim 1 in which the control system is arranged to allow re-starting of the engine and some limited running of the engine after the engine has been shut down by the sender indicating an incipient risk of the fuel system losing its prime due to insufficient fuel in the tank.

8. A motor vehicle as set forth in claim 7 in which the control system is arranged to allow re-starting of the engine and some running of the engine after the engine has been shut down by the sender indicating an incipient risk of the fuel system losing its prime due to insufficient fuel in the tank, provided that an ignition switch has been first operated to OFF position.

9. A method of avoiding loss of prime in a primed fuel system of a diesel engine that propels a motor vehicle having a fuel tank for holding diesel fuel for the engine and a sender for indicating the level of diesel fuel in the tank, the method comprising:
with the engine running, shutting down the engine when the sender indicates an incipient risk of the fuel system losing its prime due to insufficient fuel in the tank.

10. A method as set forth in claim 9 including referencing the indicated level of fuel to the bottom of the tank by forcing a bottom referencing element against the bottom of the tank.

11. A method as set forth in claim 9 including processing a fuel level signal from the sender according to an algorithm that attenuates the effect of fuel slosh in the tank on fuel level indicated by the sender.

12. A method as set forth in claim 9 including issuing a low-fuel warning at an indicated fuel level in advance of a level indicating an incipient risk of the fuel system losing its prime due to insufficient fuel in the tank.

13. A method as set forth in claim 12 including issuing an imminent shutdown warning in advance of the control system shutting down the engine because of the sender indicating an incipient risk of the fuel system losing its prime due to insufficient fuel in the tank, but at a lower indicated fuel level than the level at which the low-fuel warning was issued.

14. A method as set forth in claim 9 including disallowing re-starting of the engine until fuel has been added to the tank to bring the fuel level to one that is higher than the one that caused the shutdown.

15. A method as set forth in claim 9 including allowing re-starting of the engine and some limited running of the engine after the engine has been shut down by the sender indicating an incipient risk of the fuel system losing its prime due to insufficient fuel in the tank.

16. A method as set forth in claim 15 comprising allowing re-starting of the engine and some running of the engine after the engine has been shut down by the sender indicating an incipient risk of the fuel system losing its prime due to insufficient fuel in the tank upon operating an ignition switch to OFF position.
